(19) United States
(12) Patent Application Publication
(10) Pub. No.: US 2010/0256036 A1
(43) Pub. Date: Oct. 7, 2010

(54) Detergents Containing Nitrogen-Containing Cosurfactants

(76) Inventors: Konstantin Benda, Düsseldorf (DE); Matthias Sunder, Düsseldorf (DE); Michael Dreja, Neuss (DE)

Correspondence Address: Henkel Corporation, 10 Finderne Avenue, Suite B, Bridgewater, NJ, 08807, US

(21) Appl. No.: 12/816,728

(22) Filed: Jun. 16, 2010

Related U.S. Application Data
(63) Continuation of application No. PCT/EP08/67476, filed on Dec. 15, 2008.

(30) Foreign Application Priority Data
Dec. 20, 2007 (DE) 10 2007 062 518.0

(51) Int. Cl. C11D 3/26

(52) U.S. Cl. 510/299

(57) ABSTRACT

Method for improving the primary detergency of detergents, especially for washing textiles soiled with oil- and/or fat-containing materials. This is accomplished by incorporation of nitrogen-containing surfactants, produced in particulate form.

### CROSS REFERENCE TO RELATED APPLICATIONS

The present application is a continuation of International Application No. PCT/EP2008/067476 filed 15 Dec. 2008, which claims priority to German Patent Application No. 10 2007 062 518.0 filed 20 Dec. 2007.

The present invention relates to a method of enhancing the primary detergency of washing agents in washing textiles soiled with oil and/or fat by adding nitrogen-containing cosurfactants finished in solid form.

In addition to ingredients such as surfactants and builder materials, which are indispensable for the washing process, washing agents usually contain additional ingredients. These additional ingredients can be combined together under the term “washing aids”, comprising different groups of active ingredients such as foam regulators, graying inhibitors, bleaching agents, bleach activators and dye transfer inhibitors. Washing aids also include substances that enhance the detergency of surfactants, usually without having a pronounced surfactant behavior. The same thing also applies to cleaning agents for hard surfaces. Such substances are often referred to as detergency boosters or “fat boosters” because of their especially pronounced effect on oil-based or fat-based soiling.

It is known that nitrogen-containing cosurfactants improve the primary washing performance on soiling containing fat and pigment. However, these surfactants are difficult to formulate into particulate washing and cleaning agents because they are usually in paste or liquid form at room temperature.

In one embodiment, the subject matter of the present invention is directed towards granules containing 10 wt % to 90 wt % nitrogen-containing cosurfactant, 10 wt % to 90 wt % carrier material and up to 50 wt % binder, based on total weight of the granule.

The term granules within the scope of the present invention includes agglomerates, powders, coated particles, prills, etc.

The essential component of the inventive granules is a nitrogen-containing cosurfactant, preferably present in the granules in an amount of 11 wt % to 85 wt %, preferably from 12 wt % to 80 wt %, especially preferably from 13 wt % to 75 wt %, more preferably from 14 wt % to 70 wt %, especially 15 wt % to 65 wt %, more preferably here from 16 wt % to 60 wt %, most especially preferably from 17 wt % to 55 wt % and in particular from 18 wt % to 50 wt %, where the percentage amounts are based on the granules.

Preferred cosurfactants include primary, secondary and tertiary alkylamines, alkyl-alkylenediamines, N-alkyl-substituted bisaminoalkylamines, alkylamine oxides, alkylbetaines, aminoethoxylates, N-alkylpyrrolidones, alkyliminoglycinates, alkyliminopropionates, alkyliminodipropionates, alkylamine oxide ethoxylates and/or mixtures of at least two of these. Of the alkylalkylenediamines and/or bisaminoalkylamines, those that are especially preferred are alkyl-ethylenediamines and alkylpropylenediamines and/or bisaminoethylamines and bisaminopropylamines.

Alkyl groups that may be used in these cosurfactants are preferably linear or branched C₆-C₂₂ groups, in particular C₈-C₁₈ groups. Of their branched members, those that are preferred have methyl, ethyl and/or propyl substituents on their longest C chain. Of these, the isotridecyl group is especially preferred. If the nitrogen-containing cosurfactant has multiple alkyl groups, e.g., the secondary or tertiary amines, it contains at least one alkyl group of the aforementioned length with 6 to 22 carbon atoms, in particular 8 to 18 carbon atoms. The other group(s) is (are) preferably short-chain group(s) (e.g., methyl and/or ethyl). Of the alkylamine oxides and/or alkylbetaines, C₈₋₂₂ alkyldimethylamine oxides and/or C₈₋₂₂ alkyldimethylbetaines are preferred.

Another subject matter of the invention is use of particulate nitrogen-containing cosurfactants for improving the primary detergency of washing agents, in particular particulate washing agents in washing textiles soiled with oil- and/or fat-based soiling. The soil need not consist exclusively of oil or fat. Nitrogen-containing cosurfactants that are in particulate form may advantageously be used against soiling that is otherwise difficult to remove and which also contains pigment.

Another subject matter of the present invention is a method for removing oil- and/or fat-based soiling from textiles by using a washing agent, in particular a particulate washing agent, containing a nitrogen-containing cosurfactant in the form of particles. This method may be implemented manually, or preferably with the help of a conventional household washing machine. It is possible here to use the washing agent, in particular the particulate washing agent, and nitrogen-containing cosurfactant finished in particulate form either simultaneously or in succession. Simultaneous use may be implemented especially advantageously with use of a washing agent containing the nitrogen-containing cosurfactant finished in particulate form. The entire particulate washing or cleaning agent may consist of particles comprising the nitrogen-containing cosurfactant. However, preferably the nitrogen-containing cosurfactant particles contain only carrier materials and optionally binder in addition to the nitrogen-containing cosurfactant, and are processed by mixing them with particles having a different composition (e.g., builder granules, surfactant granules, bleaching agent particles and/or enzyme granules) to form the finished product.

Carrier material can be present in the inventive granules in an amount of 10 to 90 wt %. The granules preferably contain 15 to 85 wt %, more preferably 20 to 80 wt %, even more preferably 30 to 75 wt %, especially preferably 35 to 70 wt %, and in particular 40 to 65 wt % carrier material, based on total weight of the granule. Preferred carrier materials include carbonates, bicarbonates, sesquicarbonates, sulfates, silicates, sheet silicates, in particular bentonites, aluminosilicates, in particular zeolites, silicic acids, starch, cellulose, cellulose derivatives, citric acid, citrates, tripoly-phosphates and mixtures of at least two of these.

The carrier material preferably has an oil absorption capacity of from 10 mL/100 g to 160 mL/100 g, preferably 12.5 mL/100 g to 120 mL/100 g and in particular 15 mL/100 g to 80 mL/100 g. Oil absorption capacity is a physical property of a substance, which can be determined according to standardized methods (ISO 787/5). In the test methods, a weighed sample of the respective substance is placed on a plate and drop-wise mixed with refined linseed oil (density 0.93 g·cm⁻³) from a biuret. After each addition, the powder is mixed thoroughly with the oil using a spatula, with oil addition continued until achieving a paste with a supple consistency. This paste should flow and/or run without forming crumbs. The oil absorption capacity is the amount of oil added by drops until reaching this state, based on 100 g absorbent, and is given in mL/100 g or g/100 g, but conversions between these values are readily possible based on the density of linseed oil.

The cosurfactant granules may optionally comprise binders in amounts of up to 50 wt %. It has been found that pourability of the inventive cosurfactant granules can be improved if the granules contain at least 5 wt %, preferably at least 10 wt %, especially at least 15 wt % and in particular at least 20 wt % binder. Especially suitable binders are solid in substance at room temperature and pressure of 1 bar. Binders for use in the inventive cosurfactant granules preferably comprise polymers and/or anionic surfactants. To produce the granules, they may, if desired, be used in aqueous solution and/or in mixture with water.

Preferable polymers include copolymeric polycarboxylates, particularly (meth)acrylic acid and maleic acid, in particular, those having a relative molecular weight of 500 to 70,000 g/mol.

Molecular weights given for polymeric polycarboxylates are weight-average molecular weights M_{w} of the respective acid form, determined by gel permeation chromatography (GPC) using a UV detector. Measurements were performed against an external polyacrylic acid standard, which yields realistic molecular weights due to its structural similarity to the polymers tested. This information deviates significantly from molecular weight information using polystyrene sulfonic acids as the standard. Molecular weights measured against polystyrene sulfonic acids are usually much higher than molecular weights given in the present document.

Suitable polymers include in particular polyacrylates preferably having a molecular weight of 2000 to 20,000 g/mol. Based on their superior solubility, short-chain polyacrylates having molecular weights of 2000 to 10,000 g/mol, and especially from 3000 to 5000 g/mol are preferred from this group.

In addition, copolymeric polycarboxylates are suitable, particularly those of acrylic acid with methacrylic acid and acrylic acid or methacrylic acid with maleic acid. Copolymers of acrylic acid with maleic acid containing 50 to 90 wt % acrylic acid and 50 to 10 wt % maleic acid have proven to be especially suitable. Their molecular weight, based on free acids, is generally 2000 to 70,000 g/mol preferably 20,000 to 50,000 g/mol and in particular 30,000 to 40,000 g/mol.

In a preferred specific embodiment of the invention, polyester-active soil-release polymers are used. These include copolyesters of dicarboxylic acids (e.g., adipic acid, phthalic acid or terephthalic acid), diols (e.g., ethylene glycol or propylene glycol), and polydiols (e.g., polyethylene glycol or polypropylene glycol). Preferred soil release polyesters include compounds accessible by esterification of two monomer parts, such that the first monomer is a dicarboxylic acid, HOOC-Ph-COOH, and the second monomer is a diol, HO—(CHR¹¹)ₐOH, which may also be present as a polymeric diol H—(O—(CHR₁₁)ₐ)_{b}OH, in which Ph denotes an o-, m- or p-phenylene radical having 1 to 4 substituents chosen from alkyl radicals with 1 to 22 carbon atoms, sulfonic acid groups, carboxyl groups and mixtures thereof, R¹¹ denotes hydrogen, an alkyl radical with 1 to 22 carbon atoms and mixtures thereof, a denotes a number from 2 to 6, and b denotes a number from 1 to 300. Polyesters obtainable from them preferably contain both monomeric diol units, —O—(CHR₁₁)ₐ—O—, and polymeric diol units, —(O—(CHR¹¹)ₐ)_{b}O—. Molar ratio of monomeric diol units to polymeric diol units is preferably 100:1 to 1:100, in particular 10:1 to 1:10. The degree of polymerization b in the polymeric diol units is preferably in the range of 4 to 200, particularly 12 to 140. The molecular weight and/or average molecular weight or maximum of the molecular weight distribution of preferred soil release polyesters is in the range of 250 to 100,000, in particular from 500 to 50,000. The acid on which the radical Ph is based is preferably chosen from terephthalic acid, isophthalic acid, phthalic acid, trimellitic acid, mellitic acid, the isomers of sulfophthalic acid, sulfoisophthalic acid and sulfoterephthalic acid as well as mixtures thereof. If their acid groups are not part of the ester linkages in the polymer, then they are preferably in salt form, in particular as the alkali or ammonium salt. Of these, the sodium and potassium salts are especially preferred. If desired, instead of the monomer HOOC-Ph-COOH, small amounts of other acids having at least two carboxyl groups, in particular no more than 10 mol %, based on the amount of Ph, with the meaning given above, may also be present in the soil release polyester. These include, for example, alkylene- and alkenylenedicarboxylic acids such as malonic acid, succinic acid, fumaric acid, maleic acid, glutaric acid, adipic acid, pimelic acid, suberic acid, azelaic acid and sebacic acid. Preferred diols HO—(CHR¹¹)ₐOH include those wherein R¹¹ is hydrogen and a is a number from 2 to 6, and those wherein a is 2 and R¹¹ is chosen from hydrogen and alkyl radicals with 1 to 10 carbon atoms, in particular 1 to 3 carbon atoms. Of the latter diols, those of the formula HO—CH₂—CHR¹¹—OH, wherein R¹¹ has the meanings given above, are especially preferred. Examples of diol components include ethylene glycol, 1,2-propylene glycol, 1,3-propylene glycol, 1,4-butanediol, 1,5-pentanediol, 1,6-hexanediol, 1,8-octanediol, 1,2-decanediol and neopentyl glycol. Of the polymeric diols, polyethylene glycol with an average molecular weight in the range of 1000 to 6000 is especially preferred.

If desired, these polyesters having the compositions described above may also be end group capped, where alkyl groups with 1 to 22 carbon atoms (e.g., methyl, ethyl or propyl groups) and esters of monocarboxylic acids may be used as the end groups. End groups bound by ester linkages may be based on alkyl-, alkenyl- and arylmonocarboxylic acids with 5 to 32 carbon atoms, in particular 5 to 18 carbon atoms. These include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselinic acid, petroselaidic acid, oleic acid, linoleic acid, linolaidic acid, linolenic acid, eleostearic acid, arachic acid, gadoleic acid, arachidonic acid, behenic acid, erucaic acid, brassidic acid, clupanodonic acid, lignoceric acid, cerotic acid, melissic acid, benzoic acid, which may have 1 to 5 substituents with a total of up to 25 carbon atoms, in particular 1 to 12 carbon atoms, e.g., tert-butylbenzoic acid. The terminal groups may also be based on hydroxy-monocarboxylic acids with 5 to 22 carbon atoms, including, for example, hydroxyvaleric acid, hydroxycaproic acid, ricinoleic acid, their hydrogenation product hydroxystearic acid and o-, m- and p-hydroxybenzoic acid. The hydroxymonocarboxylic acids may in turn be linked together by their hydroxyl group and their carboxyl group and may thus be present repeatedly in one end group. The number of hydroxymonocarboxylic acid units per end group, i.e., their degree of oligomerization is preferably in the range of 1 to 50, in particular from 1 to 10. In a preferred embodiment of the invention, polymers of ethylene terephthalate and polyethylene oxide terephthalate, in which the polyethylene glycol units have molecular weights of 750 to 5000 and the molar ratio of ethylene terephthalate to polyethylene oxide terephthalate is 50:50 to 90:10, are used in combination with an inventive nitrogen-containing cosurfactant.

Soil release polymers are preferably water-soluble, where “water-soluble” refers to a solubility of at least 0.01 g, preferably at least 0.1 g of the polymer per liter of water at room temperature and a pH of 8. However, polymers preferred for use here have a solubility of at least 1 g per liter, in particular at least 10 g per liter, under these conditions.

Useful anionic surfactants include soaps and/or sulfonates and/or sulfates. Of the soaps, salts of saturated fatty acids with 6 to 22 carbon atoms (e.g., caproic acid, caprylic acid, capric acid, myristic acid, lauric acid, palmitic acid, stearic acid or behenic acid) are preferred. Preferred sulfonate surfactants include C₉₋₁₃ alkylbenzene sulfonates, olefin sulfonates (i.e., mixtures of alkene and hydroxyalkane sulfonates and disulfonates) such as those obtained, for example, from C₁₂₋₁₈ monoolefins with terminal or internal double bonds by sulfonation of gaseous sulfur trioxide and subsequent alkaline or acidic hydrolysis of the sulfonation products. Alkane sulfonates obtained from C₁₂₋₁₈ alkanes by sulfochlorination or sulfoxidation with subsequent hydrolysis and/or neutralization are also suitable. Esters of α-sulfo fatty acids (ester sulfonates, e.g., α-sulfonated methyl esters of hydrogenated coco, palm kernel or tallow fatty acids) are also suitable.

Other suitable anionic surfactants include sulfated fatty acid glycerol esters. Fatty acid glycerol esters include mono-, di- and triesters as well as mixtures thereof, such as those obtained in synthesis by esterification of a monoglycerol with 1 to 3 mol fatty acid or in transesterification of triglycerides with 0.3 to 2 mol glycerol. Preferred sulfated fatty acid glycerol esters are the sulfation products of saturated fatty acids with 6 to 22 carbon atoms (e.g., caproic acid, caprylic acid, capric acid, myristic acid, lauric acid, palmitic acid, stearic acid or behenic acid).

Preferred alk(en)yl sulfates include the alkali salts, and in particular the sodium salts of sulfuric acid hemiesters of C₁₂-C₁₈ fatty alcohols (e.g., from coco fatty alcohol, tallow fatty alcohol, lauryl, myristyl, cetyl or stearyl alcohol) or the C₁₀-C₂₀ oxo alcohols and the hemiesters of secondary alcohols of these chain lengths. Also preferred are alk(en)yl sulfates of the aforementioned chain length containing a synthetic linear alkyl radical synthesized on a petrochemical base having a degradation behavior similar to that of the adequate compounds based on raw materials from fat chemistry. Of interest in washing agent technology are the C₁₂-C₁₆ alkyl sulfates and C₁₂-C₁₅ alkyl sulfates as well as C₁₄-C₁₅ alkyl sulfates. Also 2,3-alkyl sulfates are suitable anionic surfactants.

Sulfuric acid monoesters of linear or branched C₇₋₂₁ alcohols ethoxylated with 1 to 6 mol ethylene oxide, such as 2-methyl-branched C₉₋₁₁ alcohols with an average of 3.5 mol ethylene oxide (EO) or C₁₂₋₁₈ fatty alcohols with 1 to 4 EO are suitable.

Additional suitable anionic surfactants include the salts of alkyl sulfosuccinic acid, also known as sulfosuccinates or sulfosuccinic acid esters, and the monoesters and/or diesters of sulfosuccinic acid with alcohols, preferably fatty alcohols and in particular ethoxylated fatty alcohols. Preferred sulfosuccinates contain C₈₋₁₈ fatty alcohol radicals or mixtures thereof. Sulfosuccinates that are preferred in particular contain a fatty alcohol radical derived from ethoxylated fatty alcohols, which are nonionic surfactants when considered separately. Again, sulfosuccinates in which the fatty alcohol radicals are derived from ethoxylated fatty alcohols with a narrow-range homolog distribution are especially preferred. It is likewise possible to use alk(en)yl succinic acid, preferably with 8 to 18 carbon atoms in the alk(en)yl chain, or their salts.

Anionic surfactants can be present in the form of their sodium, potassium or ammonium salts, and as soluble salts of organic bases such as mono-, di- or triethanolamine. They are preferably present in the form of their sodium or potassium salts, in particular in the form of sodium salts.

Preferred anionic surfactants are fatty alcohol sulfates, fatty alcohol ether sulfates, alkylbenzene sulfonates, alkane sulfonates, olefin sulfonates, methyl ester sulfonates and/or stearates.

In preferred specific embodiments, polymers and/or surfactants present in the binder have a melting point of at least 25° C.

It has been found that the inventive granules have an especially good solubility if the weight ratio of binder to nitrogen-containing cosurfactant in the granules is in the range of 5:1 to 1:4, preferably 4:1 to 1:2 and in particular 3:1 to 1:1. This is true in particular when anionic surfactant(s) is (are) contained as the binder.

Other conventional ingredients of washing or cleaning agents can also be a component of the inventive cosurfactant granules. However, preferably the inventive granules contain such additional optional ingredients (described in greater detail below) in amounts of 50 wt % or less, preferably 40 wt % or less, especially preferably 30 wt % or less, more preferably 20 wt % or less, and in particular 10 wt % or less, based on total weight of the cosurfactant granules.

According to a preferred embodiment of the invention, the inventive cosurfactant granules are uniformly shaped, preferably almost spherically or elliptically. Average shape factor of the granules is preferably at least 0.79, especially at least 0.81, advantageously at least 0.83, more preferably at least 0.85 and in particular at least 0.87. The shape factor, also known as the roundness factor, can be determined accurately by modern particle measurement techniques using digital image processing. A typical suitable particle shape analysis such as that performed using the Camsizer® system from Retsch Technology or using the KeSizer® from Kemira, for example, is based on irradiation of particles with a light source and detection of the particles as projected areas, which are then digitized and processed by computer. The surface curvature is determined by an optical measurement method in which the “shadow projection” of the parts to be analyzed is measured and converted to a corresponding shape factor. The measurement limits of this optical method of analysis are 15 μm and 90 mm, respectively. Those skilled in the art are familiar with methods of determining the shape factor for larger particles. These are usually based on the principles of the aforementioned methods.

The inventive granules preferably have a particle size distribution wherein at least 75 wt %, preferably at least 85 wt % and in particular at least 95 wt % of the particles are between 200 and 2500 μm in size, preferably between 250 and 2000 μm and in particular between 300 and 1600 μM. Average particle diameter d₅₀ of the cosurfactant granules is preferably in a range of 200 to 1800 μm. Those skilled in the art are familiar with suitable methods for determining the particle size as well as the average particle diameter of powders, granules and agglomerates, referred to here simply as granules. For example, particle sizes can be determined by screen analyses. The term “average particle diameter d₅₀” is understood to refer to the value at which 50% of the particles have a smaller diameter, and 50% of the particles (each based on the particle count) have a larger diameter. Accordingly, the d₉₀ value of a particle size distribution is understood to refer to the diameter at which 90% of the particles have a smaller diameter and 10% of the particles have a larger diameter (again, each based on the particle count).

If the inventive cosurfactant granules are mixed with a spray-dried powder, for example, then the average particle diameter d₅₀ is preferably in a range of 200 to 600 μm, especially 250 to 550 μM and in particular 300 to 500 μm. However, if the intention is to mix the inventive granules with a coarse-grained powder base, then the average particle diameter of the granules is preferably in a range from 500 to 2000 μm, preferably from 600 to 1900 μm, especially preferably from 700 to 1800 μm and in particular from 800 to 1700 μm.

A uniform particle size and thus a narrow particle size distribution contribute to a positive overall impression of granules. We speak of a uniform particle size when the particles have a size distribution in which the ratio of d₅₀ to d₉₀ amounts to at least 0.50, preferably at least 0.6, especially at least 0.75 and in particular at least 0.80. The inventive cosurfactant granules preferably have these properties.

Furthermore, the inventive granules, even if they contain poorly dispersible carrier materials, have an improved solubility/dispersion capability. The residue value of the granules can be determined by means of a standardized solubility test. To do so, 50 g of the sample to be measured is added to 1000 mL tap water (water hardness 16° d, 30° C.) which is being agitated by means of a propeller stirrer in a glass beaker. After 90 seconds, the solution is poured through a previously weighed screen (0.2 mm mesh) and the devices used are rerinsed with a small amount of water, and then this water is also poured through the screen. After drying the screen at 40° C. to a constant weight, the screen is weighed in the “filled” state. The residue is given in percent, based on the weight of the sample to be measured. For the inventive cosurfactant granules, which comprise less than 10 wt % anionic surfactant or none at all, the residue value preferably amounts to less than 15 wt %, especially less than 10 wt % and in particular less than 5 wt %. It is known that gelling occurs when granules containing anionic surfactants and in particular alkylbenzene sulfonates and nonionic surfactants at the same time are brought in contact with water. This results in a low solubility/dispersibility of the corresponding granules. It has surprisingly been found that inventive cosurfactant granules containing anionic surfactant have a better solubility/dispersibility than known granules containing anionic surfactant and nonionic surfactant, which can be quantified by the stated solubility test. The residue value of inventive cosurfactant granules containing anionic surfactant is preferably below 70 wt %, especially below 60 wt %, preferably below 50 wt % and in particular below 40 wt %. Especially preferred inventive cosurfactant granules containing anionic surfactant have a residue value significantly below 30 wt %.

To produce inventive cosurfactant granules, a method in which carrier material is fluidized in a mixer and liquid components are applied to the fluidized carrier material is preferably used.

The term “liquid components” here also includes those components which are solid at 25° C. and 1 bar but are liquid under process conditions, as is the case in melting, for example.

This method makes it possible to produce cosurfactant-containing granules having the claimed concentration of cosurfactant and having a satisfactory solubility and pourability with regard to use in washing or cleaning agents.

The nitrogen-containing cosurfactant in the form of a cosurfactant preparation and optionally a binder preparation which is liquid (under the process conditions) are used as the liquid component in this method. The use of additional liquid components is possible but not preferred.

The term “cosurfactant preparation” refers to flowable and/or sprayable aqueous or nonaqueous preparations containing substantial amounts (at least 5 wt %) of cosurfactant. Preferably an aqueous cosurfactant preparation having active substance content (cosurfactant content) of 10 to 50 wt % and in particular 20 to 40 wt % is used. Cosurfactant preparations used preferably contain 5 wt % or less of other components in addition to the solvent, preferably water, and the cosurfactant.

The term “binder preparation” comprises individual solid or liquid binders and mixtures, which contain exclusively solid binders, exclusively liquid binders or solid and liquid binders, optionally in mixture with one or more solvents. The properties “solid” and “liquid” within the context of this section refer to the state of the respective binder in substance at 25° C. and 1 bar. Binder preparations containing one or more solid binders and a solvent (mixture), in particular water, are preferred for use in the production process.

In a preferred specific embodiment of the method, a cosurfactant preparation and a binder preparation are dosed separately to the mixer. However, it may be preferable to dose a cosurfactant-binder mixture prepared in advance to the mixer.

The cosurfactant preparation and/or the cosurfactant-binder mixture preferably contain(s) 20 to 90 wt %, especially 40 to 85 wt % and in particular 60 to 80 wt % water.

Especially stable inventive cosurfactant granules with a good solubility and good pourability are obtained when the liquids are used in the most neutral possible form. To do so, the liquid components are preferably adjusted to a neutral pH with citric acid. The cosurfactant preparation introduced into the mixer and the binder preparation optionally used or the cosurfactant-binder mixture preferably have a pH of 5 to 9, especially 6 to 8 and in particular from 6.5 to 7.5.

The cosurfactant preparation, the binder preparation and/or the cosurfactant-binder mixture are preferably sprayed onto the moving carrier material by means of nozzles. The spraying may be accomplished by means of single-substance spray nozzles and/or high-pressure spray nozzles, two-substance spray nozzles or three-substance spray nozzles. For spraying using single-substance nozzles, the use of a high mass pressure is necessary, whereas spraying in two-substance nozzles is accomplished with the help of a stream of compressed air. Spraying with two-substance nozzles is more favorable, especially with regard to possible blockage of the nozzle, but is also more complex due to the high consumption of compressed air. As a modern refinement, there are also three-substance nozzles, which have another air guidance system in addition to the compressed air stream for atomization, thus preventing blockages and formation of droplets at the nozzle. In the production of the inventive granules, the use of two-substance nozzles is especially preferred. The liquid components are preferably sprayed onto the carrier material as uniformly as possible.

All the low-, moderate- and high-speed shearing mixers with which those skilled in the art are familiar may be used in the method for producing the cosurfactant granules. Suitable mixers include gravity mixers, thrust mixers, gravity mixers and turbulent mixers. Preferred gravity mixers include drum mixers, tumbling mixers, cone mixers, double-cone mixers and V-type mixers. Thrust mixers are mixers having moving mixing tools, in which the mixing tools move at a low speed. Examples of suitable mixers include screw mixers and helical belt mixers. High-speed mixers with moving mixing tools are referred to as turbulent mixers and comprise, for example, paddle mixers, plowshare mixers, blade mixers and ribbon mixers. Pan mixers and countercurrent intense mixers are preferably used as mixers having moving containers and moving mixing tools. Suitable gravity mixers include, among others, mixing silos, bunkers or belts. Suitable pneumatic mixers are in turn regarded as mixing silos, fluidized bed mixers and jet mixers.

The method is especially preferably performed in a pneumatic fluidized bed. To perform the method in the fluidized bed, it has proven advantageous to control the temperatures of the inlet air, the fluidized bed and the sprayed liquid components. Within the scope of the present invention, preferred methods are those in which the temperature of the inlet air is from 30° C. to 220° C., preferably from 60° C. to 210° C. and in particular from 90° C. to 200° C. and/or the fluidized bed has a temperature of 30° C. or greater, preferably 45° C. or greater, and in particular 60° C. or greater, while the liquid components are being sprayed and/or the sprayed liquid components have a temperature 30° C. or greater, preferably 40° C. or greater, and in particular 50° C. or greater. If the liquid components are heated before spraying, a higher throughput can be achieved.

However, there are also advantages in not heating the liquid components before spraying them and using them at a temperature of from 0° C. up to max. room temperature, preferably 10° C. or greater and in particular 20° C. or greater, because in this way, equipment complexity can be reduced due to the heat exchanger not being needed in this embodiment.

To produce finished washing and cleaning agents, inventive cosurfactant granules are preferably mixed with other particulate components containing other ingredients desired in the agent.

In a preferred specific embodiment of the present invention, washing or cleaning agent compositions comprising the inventive cosurfactant granules, preferably comprising additional surfactant- and/or builder-containing granules and optionally other solid or liquid components are compressed to form a molded article.

To facilitate disintegration of the prefabricated molded articles, it is possible to incorporate disintegration aids, so-called tablet disintegrants, into these agents to shorten disintegration times. Tablet disintegrants and/or disintegration accelerators are aids that ensure rapid disintegration of tablets in water or other media and prompt release of active ingredients.

These substances, also designated as disintegrants based on their effect, increase their volume on admission of water so that the inherent volume can be increased (swelling) and pressure can be generated by the release of gases, causing the tablet to disintegrate into smaller particles. Familiar disintegration aids include, for example, carbonate/citric acid systems, but other organic acids may also be used. Swelling disintegration aids include, for example, synthetic polymers such as polyvinylpyrrolidone (PVP) or natural polymers and/or modified natural substances such as cellulose and starch and their derivatives, alginates or casein derivatives.

Disintegrants based on cellulose are preferred disintegrants for use here. Pure cellulose has the formal empirical composition (C₆H₁₀O₅)ₙ and, considered formally, is a β-1,4-polyacetal of cellobiose, which is in turn composed of two molecules of glucose. Suitable celluloses comprise approximately 500 to 5000 glucose units and consequently have average molecular weights of 50,000 to 500,000. Cellulose-based disintegrants that may be used within the scope of the present invention also include cellulose derivatives obtainable by polymer-like reactions from cellulose. Such chemically modified celluloses comprise, for example, products of esterifications and/or etherifications, in which hydroxy hydrogen atoms are substituted. However, celluloses in which the hydroxy groups have been replaced by functional groups not bound by an oxygen atom can also be used as cellulose derivatives. The cellulose derivative group includes, for example, alkali celluloses, carboxymethyl cellulose (CMC), cellulose esters and ethers as well as amino celluloses. These cellulose derivatives are preferably not used only as cellulose-based disintegrants, but instead are used in mixture with cellulose. The cellulose derivative content of these mixtures is preferably less than 50 wt %, especially preferably less than 20 wt %, based on the cellulose-based disintegrant. Pure cellulose free of cellulose derivatives is especially preferably used as the cellulose-based disintegrant.

Cellulose used as the disintegration aid is preferably not used in finely divided form but instead is converted to a coarser form (e.g., by granulation or compacting) before being mixed with the premixes to be compressed. Particle sizes of such disintegrants are at least 200 μm or greater, preferably at least 90 wt % being from 300 to 1600 μm, and in particular at least 90 wt % being from 400 μm to 1200 μm.

Microcrystalline cellulose can be used as an additional cellulose-based disintegrant or as an ingredient of these components. Microcrystalline cellulose is obtained by partial hydrolysis of celluloses under conditions which attack only the amorphous regions (approximately 30% of the total cellulose mass) of the celluloses and completely dissolve them but leave the crystalline regions (approximately 70%) undamaged. Subsequent deaggregation of microfine celluloses formed by hydrolysis yields microcrystalline celluloses having primary particle sizes of approximately 5 μm and can be compacted to form granules with an average particle size of 200 μm, for example.

In addition, gas-evolving effervescent systems may also be used as tablet disintegration aids. The gas-evolving effervescent system may comprise a single substance, which releases a gas on contact with water. Of these compounds, magnesium peroxide, which releases oxygen on contact with water, should be mentioned in particular. However, the gas-releasing effervescent system usually in turn has at least two ingredients, which react with one another to form a gas. Although a variety of systems, which release nitrogen, oxygen or hydrogen, for example, are conceivable and implementable here, the effervescent system used in the washing and cleaning agents is to be selected on the basis of both economic and ecological factors. Preferred effervescent systems consist of alkali metal carbonate and/or bicarbonate and an acidifying agent suitable for releasing carbon dioxide from the alkali metal salts in aqueous solution.

Boric acid and alkali metal hydrogen sulfates, alkali metal dihydrogen phosphates and other inorganic salts can be used as acidifying agents, which release carbon dioxide from the alkali salts in aqueous solution. However, organic acidifying agents are preferred, with citric acid being an especially preferred acidifying agent. Acidifying agents from organic di-, tri- and oligocarboxylic acids and/or mixtures are preferred in the effervescent system.

An agent containing cosurfactant granules to be used according to the invention or used together with them and/or used in the inventive method preferably contains bleaching agents based on peroxygen, particularly in amounts of 5 wt % to 70 wt %, as well as optionally a bleach activator, in particular in amounts of 2 wt % to 10 wt %, based on weight of the agent. Bleaching agents that can be used are preferably peroxygen compounds commonly used in washing agents such as percarboxylic acids (e.g., dodecane diperacid or phthaloyl aminoperoxycaproic acid), hydrogen peroxide, alkali perborate, which may be in the form of the tetrahydrate or monohydrate, percarbonate, perpyrophosphate and persilicate, which are usually in the form of alkali salts, in particular sodium salts. Such bleaching agents are preferably used in washing agents in amounts of up to 25 wt %, in particular up to 15 wt % and especially preferably from 5 wt % to 15 wt %, based on weight of the total agent, but percarbonate is preferably used.

Component of bleach activators optionally present in washing and cleaning agents comprising the N- or O-acyl compounds generally used, e.g., polyacylated alkylenediamines, in particular tetraacetyl-ethylenediamine, acylated glycolurils, in particular tetraacetyl glycoluril, N-acylated hydantoins, hydrazides, triazoles, urazoles, diketopiperazines, sulfurylamides and cyanurates as well as carboxylic acid anhydrides, in particular phthalic acid anhydride, carboxylic acid esters, in particular sodium isononanoyl phenol sulfonate and acylated sugar derivatives, in particular pentaacetyl glucose as well as cationic nitrile derivatives, such as trimethylammonium acetonitrile salts. Bleach activators can be coated with coating substances in a known way to prevent their interaction with per compounds during storage and/or may be granulated, such that tetraacetyl-ethylenediamine granulated with the help of carboxymethyl cellulose and having average grain sizes of 0.01 mm to 0.8 mm, granulated 1,5-diacetyl-2,4-dioxohexahydro-1,3,5-triazine and/or trialkylammonium acetonitrile finished in particulate form are especially preferred. Such bleach activators are preferably present in washing agents in amounts of up to 8 wt %, in particular 2 wt % to 6 wt %, based on total weight of the agent.

In a preferred specific embodiment, an agent used according to the invention or used in the inventive method contains a nonionic surfactant chosen from polyalkyl polyglycosides, fatty alkyl polyalkoxylates, in particular ethoxylates and/or propoxylates and/or ethoxylation products and/or propoxylation products of vicinal diols and/or fatty acid alkyl esters and mixtures thereof, in particular in an amount of 2 wt % to 25 wt %.

Another specific embodiment of such agents comprises the presence of aforementioned synthetic anionic surfactant, in particular in an amount of 2 wt % to 25 wt %, where this also includes the amount optionally present as binder in the cosurfactant granules. The anionic surfactant is preferably chosen from alkyl and/or alkenyl sulfates and/or alkyl and/or alkenyl ether sulfonates, in which the alkyl and/or alkenyl group has 8 to 22 C atoms, in particular 12 to 18 C atoms. These are usually cuts or mixtures rather than individual substances. Of these, preferred ones have more than 20 wt % compounds having longer-chain residues in the range of 16 to 18 C atoms. The inventive washing or cleaning agent preferably also comprises, in addition to the inventive cosurfactant granules, additional granules containing 5 to 30 wt %, preferably 7.5 to 27.5 wt % and in particular 10 to 25 wt % anionic surfactant, especially preferably at least proportionally alkylbenzene sulfonate and/or additional surfactant-containing granules, comprising 30 to 65 wt %, preferably 35 to 55 wt %, and in particular 40 to 50 wt % anionic surfactant, most preferably at least proportionally alkylbenzene sulfonate, and/or additional surfactant-containing granules, containing 65 to 98 wt %, preferably 72.5 to 95 wt % and in particular 80 to 92 wt % anionic surfactant, especially preferably at least proportionally fatty alcohol sulfate and/or methyl ester sulfonate. The aforementioned carrier materials and the polymers of the aforementioned binders may optionally also be used to produce such surfactant granules.

Nonionic surfactants that can be considered for the washing and cleaning agents include alkoxylates, in particular ethoxylates and/or propoxylates of saturated or mono- to polyunsaturated linear or branched alcohols with 10 to 22 C atoms, preferably 12 to 18 C atoms. The degree of alkoxylation of the alcohols is usually from 1 to 20, preferably from 3 to 10. They can be synthesized by reacting the corresponding alcohols with the corresponding alkylene oxides. In particular, derivatives of fatty alcohols are suitable, although their branched isomers, in particular so-called oxo alcohols, can be used to produce alkoxylates that may be used. Accordingly, alkoxylates, in particular ethoxylates of primary alcohols with linear radicals, in particular dodecyl, tetradecyl, hexadecyl or octadecyl radicals as well as mixtures thereof can be used. Furthermore, corresponding alkoxylation products of vicinal diols or carboxylic acid esters, which correspond to the aforementioned alcohols with regard to the alkyl and/or carboxylic acid part, may also be used. So-called alkyl polyglycosides suitable for incorporation into washing and cleaning agents include compounds of the general formula (G)ₙ-OR¹², where R¹² is an alkyl or alkenyl radical with 8 to 22 carbon atoms, G is a glycose unit, and n is a number from 1 to 10. Glycoside component (G)ₙ includes oligomers or polymers of naturally occurring aldose or ketose monomers, including in particular glucose, mannose, fructose, galactose, talose, gulose, altrose, allose, idose, ribose, arabinose, xylose and lyxose. Oligomers consisting of such glycosidically linked monomers are also characterized not only by the type of sugars contained in them but also by the number n, the so-called degree of oligomerization. The degree of oligomerization n increases as the quantity to be determined analytically in the numerical values, which are usually fractions. It will have a value from 1 to 10 (e.g., glycosides, which are preferred for use here, have a value of 1.5, in particular from 1.2 to 1.4). A preferred monomer component due to its good availability is glucose. The alkyl part or alkenyl part R¹² of the glycosides preferably also originates from readily accessible derivatives of renewable raw materials, in particular from fatty alcohols, although their branched isomers, in particular so-called oxo alcohols, may also be used to synthesize glycosides that may be used here. Accordingly, primary alcohols with linear octyl, decyl, dodecyl, tetradecyl, hexadecyl or octadecyl radicals as well as mixtures thereof may be used in particular. Especially preferred alkyl glycosides contain a coco fatty alkyl radical, i.e., mixtures with essentially R¹²=dodecyl and R¹²=tetradecyl.

Such nonionic surfactant is used according to the present invention in agents containing a cosurfactant granule used according to the invention or such nonionic surfactant is used in the inventive method, preferably in amounts of 1 wt % to 30 wt %, in particular 1 wt % to 25 wt %.

If desired, the agents can also contain cationic surfactants which, if present, are preferably used in amounts of 0.5 wt % to 7 wt %.

In another embodiment, the agent contains water-soluble and/or water-insoluble builders, in particular chosen from alkali aluminosilicate, crystalline alkali silicate with a modulus of more than 1, monomeric polycarboxylate, polymeric polycarboxylate and mixtures thereof, in particular in amounts in the range of 2.5 wt % to 60 wt %, also including the quantity optionally present in the cosurfactant granules as a carrier material.

The agent preferably contains 20 wt % to 55 wt % water-soluble and/or water-insoluble organic and/or inorganic builders. The water-soluble organic builder substances include in particular those from the class of polycarboxylic acids, in particular citric acid and saccharic acids as well as the polymeric (poly)carboxylic acids, in particular polycarboxylates accessible by oxidation of the polysaccharides, polymeric acrylic acids, methacrylic acids, maleic acids and copolymers thereof, which may also contain small amounts of polymerizable substances without a carboxylic acid functionality polymerized into them. The relative molecular weight of the homopolymers of unsaturated carboxylic acids is generally from 5000 to 200,000, while that of the copolymers is from 2000 to 200,000, preferably 50,000 to 120,000, based on free acid. An especially preferred acrylic acid-maleic acid copolymer has a relative molecular weight of 50,000 to 100,000. Suitable compounds of this class, although they are less preferred, are the copolymers of acrylic acid or methacrylic acid with vinyl ethers, such as vinyl methyl ethers, vinyl esters, ethylene, propylene and styrene, in which the acid amounts to at least 50 wt %. Terpolymers containing two carboxylic acids and/or their salts as monomers and vinyl alcohol and/or a vinyl alcohol derivative or a carbohydrate as the third monomer may also be used as the water-soluble organic builder substances. The first acid monomer and/or its salt is derived from a monoethylenically unsaturated C₃-C₈ carboxylic acid and preferably from a C₃-C₄ monocarboxylic acid, in particular (meth)acrylic acid. The second acid monomer and/or its salt may be a derivative of a C₄-C₈ dicarboxylic acid, but maleic acid is especially preferred. The third monomer unit in this case is formed by vinyl alcohol and/or preferably an esterified vinyl alcohol. Preferred in particular are vinyl alcohol derivatives, which form an ester of short-chain carboxylic acids, e.g., of C₁-C₄ carboxylic acid with vinyl alcohol. Preferred terpolymers contain 60 wt % to 95 wt %, in particular 70 wt % to 90 wt % (meth)acrylic acid and/or (meth)acrylate, especially preferably acrylic acid and/or acrylate and maleic acid and/or maleate and 5 wt % to 40 wt %, preferably 10 wt % to 30 wt % vinyl alcohol and/or vinyl acetate. Most especially preferred are terpolymers in which the weight ratio of (meth)acrylic acid and/or (meth)acrylate to maleic acid and/or maleate is from 1:1 to 4:1, preferably from 2:1 to 3:1 and in particular from 2:1 to 2.5:1. Both quantities and weight ratios are based on the acids. The second acid monomer and/or its salt may also be a derivative of an alkyl sulfonic acid, which is substituted in position 2 with an alkyl radical, preferably with a C₁-C₄ alkyl radical or an aromatic radical, preferably derived from benzene or benzene derivatives. Preferred terpolymers contain 40 wt % to 60 wt %, in particular 45 to 55 wt % (meth)acrylic acid and/or (meth)acrylate, especially preferably acrylic acid and/or acrylate, 10 wt % to 30 wt %, preferably 15 wt % to 25 wt % methallyl sulfonic acid and/or methallyl sulfonate, and as the third monomer 15 wt % to 40 wt %, preferably 20 wt % to 40 wt % of a carbohydrate. This carbohydrate may be, for example, a mono-, di-, oligo- or polysaccharide, but mono-, di-, or oligosaccharides are preferred, and sucrose is especially preferred. By using the third monomer, intended breaking points are presumably incorporated into the polymer and are responsible for the good biodegradability of the polymer. These terpolymers in general have a relative molecular weight from 1000 to 200,000, preferably from 200 to 50,000, and in particular from 3000 to 10,000. They may be used in particular for preparation of liquid agents, in the form of aqueous solutions, preferably in the form of 30 to 50 wt % aqueous solutions. All the aforementioned polycarboxylic acids are usually used in the form of their water-soluble salts, in particular their alkali salts.

Such organic builder substances are preferably contained in amounts of up to 40 wt %, in particular up to 25 wt % and especially preferably from 1 wt % to 5 wt %.

In particular crystalline or amorphous alkali aluminosilicates are used as the water-insoluble, water-dispersible inorganic builder materials in amounts of up to 50 wt %, preferably no more than 40 wt %, and in liquid agents in particular from 1 wt % to 5 wt %. Of these, washing agent-grade crystalline aluminosilicates, in particular zeolite NaA and optionally NaX are preferred. Quantities close to the aforementioned upper limit are preferably used in solid particulate agents. Suitable aluminosilicates in particular do not have any particles with a grain size larger than 30 μm and they preferably consist of at least 80 wt % particles less than 10 μm in size. Their calcium binding power, which can be determined according to the specifications of German Patent DE 24 12 837, is in the range of 100 to 200 mg CaO per gram. Suitable substitutes and/or partial substitutes for the aforementioned aluminosilicate include crystalline alkali silicates, which may be present alone or in mixture with amorphous silicates. The alkali silicates that may be used as builder substances in these agents preferably have a molar ratio of alkali oxide to SiO₂ of 0.95 or less, in particular 1:1.1 to 1:12, and may be in amorphous form or crystalline form. Preferred alkali silicates include the sodium silicates, in particular the amorphous sodium silicates with a molar ratio Na₂O:SiO₂ of 1:2 to 1:2.8. Such amorphous alkali silicates are available commercially under the name Portil®, for example. In particular those having a molar ratio Na₂O:SiO₂ of 1:1.9 to 1:2.8 are preferred as the solid in production and are not added in the form of a solution. Preferably crystalline sheet silicates of the general formula Na₂SiₓO₂ₓ₊₁.yH₂O are used, where x, the so-called modulus, is a number from 1.9 to 4, and y is a number from 0 to 20, preferred values for x being 2, 3 or 4. Preferred crystalline sheet silicates are those in which x in the general formulae given above assumes values of 2 or 3. In particular both β- and δ-sodium disilicates (Na₂Si₂O₅.yH₂O) are preferred. Practically anhydrous crystalline alkali silicates prepared from amorphous alkali silicates and having the general formula given above, in which x denotes a number from 1.9 to 2.1, may be used in agents containing an active ingredient to be used according to the present invention. In another preferred specific embodiment of the inventive agents, a crystalline sodium sheet silicate having a modulus of 2 to 3 is used, such as that which can be prepared from sand and soda. Crystalline sodium silicates having a modulus in the range of 1.9 to 3.5 are used in another preferred specific embodiment of washing agents containing an active ingredient to be used according to the present invention. They are preferably present in the alkali silicates in amounts of 1 wt % to 50 wt %, and in particular 5 wt % to 35 wt %, based on the anhydrous active substance. If an alkali aluminosilicate, in particular a zeolite, is present as the additional builder substance, then the alkali silicate content is preferably 1 wt % to 15 wt %, and in particular 2 wt % to 8 wt %, based on anhydrous active substance. The weight ratio of aluminosilicate to silicate, each based on anhydrous active substances, is then preferably 4:1 to 10:1. In agents containing both amorphous and crystalline alkali silicates, the weight ratio of amorphous alkali silicate to crystalline alkali silicate is preferably 1:2 to 2:1, and in particular 1:1 to 2:1.

In addition to the aforementioned inorganic builders, additional water-soluble or water-insoluble inorganic substances may be contained in the agents, which contain an active ingredient to be used according to the invention, used together with it and/or used in inventive methods. In this context, the alkali carbonates, alkali bicarbonates and alkali silicates as well as mixtures thereof are suitable. Such additional inorganic material may be present in amounts up to 70 wt %, which also includes the amount optionally contained as carrier material in the cosurfactant granules.

In addition, the agents may also contain other ingredients typically found in washing and cleaning agents. These optional ingredients include enzymes, enzyme stabilizers, complexing agents for heavy metals (e.g., aminopolycarboxylic acids, aminohydroxypolycarboxylic acids, polyphosphonic acids and/or aminopolyphosphonic acids), foam inhibitors (e.g., organopolysiloxanes or paraffins), dyes and scents and optical brighteners (e.g., stilbene disulfonic acid derivatives). Agents containing granules to be used according to the present invention preferably contain up to 1 wt %, in particular 0.01 wt % to 0.5 wt % optical brighteners, in particular compounds from the class of substituted 4,4′-bis(2,4,6-triamino-s-triazinyl)stilbene-2,2′-disulfonic acids, up to 5 wt %, in particular 0.1 wt % to 2 wt % complexing agents for heavy metals, in particular aminoalkylene phosphonic acids and salts thereof, and up to 2 wt %, in particular 0.1 to 1 wt % foam inhibitors, where the aforementioned amounts by weight are each based on the total agents.

In addition to water, solvents that may be used in liquid agents include preferably water-miscible solvents. These include low alcohols (e.g., ethanol, propanol, isopropanol, and isomeric butanols), glycerol, low glycols (e.g., ethylene glycol and propylene glycol), and ethers that can be derived from the aforementioned classes of compounds. Cosurfactant granules to be used according to the present invention are usually present in suspended form in such liquid agents.

Enzymes that are present, if necessary, include protease, amylase, lipase, cellulase, hemicellulase, oxidase, peroxidase or mixtures thereof. Protease obtained from microorganisms such as bacteria or fungi may be considered in particular. It may be obtained from suitable microorganisms by fermentation processes in a known way. Proteases are available commercially under the brand names BLAP®, Savinase®, Esperase®, Maxatase®, Optimase®, Alcalase®, Durazym® or Maxapem®, for example. The lipase that may be used is obtained from Humicola lanuginose, from Bacillus species, from Pseudomonas species, from Fusarium species, from Rhizopus species or from Aspergillus species, for example. Suitable lipases are available commercially under the brand names Lipolase®, Lipozym®, Lipomax®, Lipex®, Amano® lipase, Toyo-Jozo® lipase, Meito® lipase and Diosynth® lipase, for example. Suitable amylases are available commercially under the brand names Maxamyl®, Termamyl®, Duramyl® and Purafect® OxAm, for example. The cellulase that may be used may be an enzyme extractable from bacteria or fungi and having an optimum pH preferably in the weakly acidic to weakly alkaline range. Such cellulases are available commercially under the brand names Celluzyme®, Carezyme® and Ecostone®.

The usual enzyme stabilizers, which are present if necessary, in the liquid agents in particular include amino alcohols (e.g., mono-, di-, triethanolamine and -propanolamine and mixtures thereof), low carboxylic acids, boric acid and/or alkali borates, boric acid-carboxylic acid combinations, boric acid esters, boronic acid derivatives, calcium salts (e.g., Ca-formic acid combinations), magnesium salts and/or sulfur-containing reducing agents.

Suitable foam inhibitors include long-chain soaps, in particular behenic soap, fatty acid amides, paraffins, waxes, microcrystalline waxes, organopolysiloxanes and mixtures thereof, which may also contain microfine, optionally silanized or otherwise hydrophobicized silicic acid. Such foam inhibitors are preferably bound to water-soluble granular carrier substances for use in particulate agents.

Wrinkle-resistant agents can be used in washing agents because textile fabrics, particularly those made of rayon, rayon staple, cotton and blends thereof, may wrinkle because the individual fibers are sensitive to bending, kinking, pressing and squeezing across the fiber direction. These include synthetic products based on fatty acids, fatty acid esters, fatty acid amides, alkylol esters, alkylolamides or fatty alcohols, which are usually reacted with ethylene oxide, or products based on lecithin or modified phosphoric acid esters.

Antimicrobial active agents can optionally be used in washing and cleaning agents to combat microorganisms. A distinction is made here between bacteriostatics and bactericides, fungistatics and fungicides, etc., depending on the antimicrobial spectrum and mechanism of action. Important substances from these groups include benzalkonium chlorides, alkylaryl sulfonates, halophenols and phenol mercuriacetate, but these compounds may also be omitted entirely.

The agents can contain antioxidants for preventing unwanted changes in the washing and cleaning agents and/or the treated textiles due to exposure to oxygen or other oxidative processes. This class of active ingredients includes substituted phenols, hydroquinones, pyrocatechols and aromatic amines, as well as organic sulfides, polysulfides, dithiocarbamates, phosphites and phosphonates.

Increased wearing comfort can result from the additional use of antistatics. Antistatics increase the surface conductivity and thus facilitate dissipation of charges that are formed. External antistatics are usually substances having at least one hydrophilic molecular ligand and form a more or less hygroscopic film on the surfaces. The antistatics, which are usually surfactants, can be subdivided into nitrogen-containing antistatics (amines, amides, quaternary ammonium compounds), phosphorus-containing antistatics (phosphoric acid esters) and sulfur-containing antistatics (alkyl sulfonates, alkyl sulfates). Lauryl (and/or stearyl) dimethylbenzylammonium chlorides are also suitable antistatics for textiles and/or as additives to washing agents which additionally yield a finishing effect.

Silicone derivatives can be used in washing agents to improve water absorption capacity and rewettability of the treated textiles, and to facilitate ironing of the treated textiles. These may additionally improve the rinse-out behavior of washing or cleaning agents. Preferred silicone derivatives include polydialkylsiloxanes or alkylarylsiloxanes in which the alkyl groups have one to five C atoms and are optionally partially or entirely fluorinated. Preferred silicones include polydimethylsiloxanes, which may optionally be derivatized and then are amino-functional or quaternized and/or have Si—OH, Si—H and/or Si—Cl bonds. Other preferred silicones include polysiloxanes modified with polyalkylene oxide, i.e., polysiloxanes having polyethylene glycols, for example, as well as dimethylsiloxanes modified with polyalkylene oxide.

Finally, UV absorbers, which are absorbed onto the treated textiles and improve the photostability of the fibers, can also be used in washing agents. Compounds having these desired properties include, for example, the compounds that are active through radiationless deactivation and derivatives of benzophenone with substituents in position 2 and/or 4. In addition, substituted benzotriazoles, acrylates that are phenyl-substituted in position 3 (cinnamic acid derivatives), optionally with cyano groups in position 2, salicylates, organic Ni complexes as well as natural substances such as umbelliferone and endogenous urocanic acid are also suitable.

Protein hydrolysates are additional active substances from the field of washing and cleaning agents and are preferably used within the scope of the present invention because of their fiber care effect. Protein hydrolysates are product mixtures obtained by acid-, base- or enzyme-catalyzed degradation of proteins. According to the invention, protein hydrolysates of both animal and plant origin may be used. Animal protein hydrolysates include, for example, elastin, collagen, keratin, silk and milk protein hydrolysates. According to the invention, the use of protein hydrolysates of plant origin, e.g., soy, almond, rice, pea, potato and wheat protein hydrolysates is preferred. Although the use of protein hydrolysates as such is preferred, amino acid mixtures obtained by other methods or individual amino acids may also be used instead, e.g., arginine, lysine, histidine or pyroglutamic acid. It is also possible to use derivatives of the protein hydrolysates, e.g., in the form of their fatty acid condensation products.

In a preferred embodiment, an agent into which cosurfactant granules according to the invention are incorporated, is particulate and contains, based on total weight of the agent, up to 25 wt %, in particular 5 wt % to 20 wt % bleaching agent, in particular alkali percarbonate, up to 15 wt %, in particular 1 wt % to 10 wt % bleach activator, 20 wt % to 55 wt % inorganic builders, up to 10 wt %, in particular 2 wt % to 8 wt % water-soluble organic builder, 10 wt % to 25 wt % synthetic anionic surfactant, 1 wt % to 5 wt % nonionic surfactant and up to 25 wt %, in particular 0.1 wt % to 25 wt % inorganic salts, in particular alkali carbonate and/or bicarbonate.

In another possible embodiment, an agent into which cosurfactant granules according to the invention is incorporated, is liquid and contains, based on total weight of the agent, 10 wt % to 25 wt %, in particular 12 wt % to 22.5 wt % nonionic surfactant, 2 wt % to 10 wt %, in particular 2.5 wt % to 8 wt % synthetic anionic surfactant, 3 wt % to 15 wt %, in particular 4.5 wt % to 12.5 wt % soap, 0.5 wt % to 5 wt %, in particular 1 wt % to 4 wt % organic builder, in particular polycarboxylate such as citrate, up to 1.5 wt %, in particular 0.1 wt % to 1 wt % complexing agent for heavy metals such as phosphonate and, in addition to the enzyme optionally present, enzyme stabilizer, dye or scent, also water in a small amount and/or water-miscible solvent. In this context, it is preferable if the densities of the agent and of the cosurfactant granules differ so little that the granules do not separate from the liquid matrix and are uniformly suspended therein.

In a preferred embodiment, the agent contains 0.1 wt % to 5 wt %, in particular 0.5 wt % to 2 wt % nitrogen-containing cosurfactant. Furthermore, 0.1 wt % to 3 wt %, in particular 0.2 wt % to 1.5 wt % soil release polyester are also preferred, the latter preferably being present at least partially, in particular completely as part of the inventive cosurfactant granules.

Use of nitrogen-containing cosurfactants finished in particulate form yields an improved washing agent performance, in particular with respect to oil-based and/or fat-/pigment-based soil, this effect being especially pronounced at use temperature less than or equal to 40° C. The inventive method for removing oil-based and/or fat-based soil is therefore preferably performed at a temperature up to 40° C., in particular at 20° C. to 35° C.

### EXAMPLES

Washing agents of the following overall composition (amounts given in wt %) were prepared

| | E1 | E2 |
|---|---|---|
| C₁₂₋₁₄ fatty alcohol with 7 EO | 5 | 4 |
| C₉₋₁₃ alkylbenzene sulfonate, Na salt | 10 | 10 |
| Soil release polyester | 1 | 1 |
| Nitrogen-containing cosurfactant | 2 | 1.5 |
| Sodium percarbonate | 15 | 18 |
| TAED | 3 | 3 |
| C₁₂₋₁₈ fatty acid, Na salt | 1 | 1.5 |
| PVA-maleic acid copolymer | 4.5 | 2 |
| Citric acid, sodium salt | 2.5 | − |
| Phosphonic acid, sodium salt | 0.5 | 0.5 |
| Sodium carbonate | 10 | 20 |
| Zeolite A | 25 | 25 |
| Silicone defoamer | 2.5 | 1.3 |
| Enzymes (amylase, protease, cellulase) | + | + |
| Dye | + | + |
| Perfume | 0.5 | 0.2 |
| Sodium sulfate | − | to 100 |
| Sodium bicarbonate | to 100 | − |

Washing agents E1 and E2 with the nitrogen-containing cosurfactant granules to be used according to the invention had a much better washing agent performance in fat/pigment soiling compared to agents that were otherwise the same but lacked these granules.

1. Method of improving the detergency of washing agents comprising:
preparing nitrogen-containing cosurfactants, wherein the cosurfactants are in granule form,
adding the cosurfactants to a powdered washing agent,
and washing textiles soiled with oil- and/or fat-based soil,
wherein the nitrogen-containing cosurfactants is at least an N-alkylpyrrolidone, and
wherein the powdered washing agent provides better removal of the oil- and/or fat-based soil versus powdered washing agents without the nitrogen-containing cosurfactants.

2. Method according to claim 1, wherein the nitrogen-containing cosurfactants are further chosen from primary, secondary and tertiary alkylamines, alkylalkylenediamines, N-alkyl-substituted bisaminoalkylamines, alkylamine oxides, alkylbetaines, aminoethoxylates, alkylaminoglycinates, alkyliminopropionates, alkyliminodipropionates, alkylamine oxide ethoxylates and mixtures thereof.

3. Method according to claim 1, wherein the alkyl group is a linear or branched C₆-C₂₂ group.

4. Method according to claim 1, wherein the alkyl group is an isotridecyl group.

5. Method according to claim 1, wherein the washing agent comprises 0.1 wt % to 5 wt % nitrogen-containing cosurfactant.

6. Method according to claim 1, wherein the washing agent comprises 0.1 wt % to 3 wt % % soil release polyester.

7. Method according to claim 6, wherein the soil release polyester is at least partially present as part of the cosurfactant granules.

8. Method according to claim 1, further comprising washing the textiles soiled with oil- and/or fat-based soil at a wash temperature of up to 40° C.

9. Granule comprising 10 wt % to 90 wt % nitrogen-containing cosurfactant, 10 wt % to 90 wt % carrier material and up to 50 wt % binder, wherein the nitrogen-containing cosurfactant is at least N-alkylpyrrolidone.

10. Granule according to claim 9 comprising 11 wt % to 85 wt % nitrogen-containing cosurfactant.

11. Granule according to claim 9 comprising 15 to 85 wt % carrier material.

12. Granule according to claim 9, wherein the carrier material is carbonate, bicarbonate, sesquicarbonate, sulfate, silicate, sheet silicate, aluminosilicate, silicic acid, starch, cellulose, a cellulose derivative, citric acid, citrate, tripolyphosphate or a mixture thereof.

13. Granule according to claim 9 comprising at least 5 wt % binder.

14. Granule according to claim 9, wherein the binder comprises polymers and/or anionic surfactants.

15. Granule according to claim 14, wherein the polymer is a polyester-active soil release copolyester of dicarboxylic acids, diols and polydiols.
